(19) United States
(12) Patent Application Publication
(10) Pub. No.: US 2005/0184957 A1
(43) Pub. Date: Aug. 25, 2005

(54) Trackball control device

(76) Inventors: Herve' Guy Bricaud, Dole (FR); David Ferraton, Crissey (FR); Yves Pizard, Dole (FR)

Correspondence Address: LEON D. ROSEN;FREILICH, HORNBAKER & ROSEN, Suite 1220, 10960 Wilshire Blvd., Los Angeles, CA, 90024, US

(21) Appl. No.: 11/076,678

(22) Filed: Mar. 10, 2005

Related U.S. Application Data
(63) Continuation-in-part of application No. PCT/EP03/50605, filed on Sep. 13, 2003.

(30) Foreign Application Priority Data
Sep. 13, 2002 (FR) 0211394

(51) Int. Cl. H01H 9/20

(52) U.S. Cl. 345/157

(57) ABSTRACT

A pair of orthogonal coding shafts (32L,32T) are rotatably mounted in a housing (22) and have rollers (42) that engage a trackball (30), so when the trackball is rotated one or both coding shafts turns. A pinion (44) is fixed to each coding shaft to turn with it. A torsion spring (50L,50T) has one end fixed to the housing and has an opposite end that forms a contact rod (70). The contact rod has an upper end lying between teeth of the pinion so the upper end of the rod is repeatedly deflected and repeatedly snaps back to its original position. The lower end of the contact rod pivots with the upper end, so the lower end repeatedly engages and disengages a lower contact element (134L, 134T) to make and break a circuit. The lower contact element is a cantilevered pin that extends orthogonal to the control rod.

### CROSS-REFERENCE

This is a continuation-in-part of PCT application PCT/EP2003/050605 filed 2 Sep. 2003 which designated the US and claimed priority from French application 0211394 filed 13 Sep. 2002.

### BACKGROUND OF THE INVENTION

The present invention relates to a control device for an electronic apparatus, in particular a device of the type commonly referred to as a “trackball”.

### SUMMARY OF THE INVENTION

The invention relates to a control device of the type comprising a plastic housing in which are arranged two orthogonal revolving coding shafts driven in rotation, each in both directions, by a control member in the form of a spherical ball mounted rotatably in the housing, and of the type in which each shaft is tied in rotation to a mobile element belonging to a generator of control signals, in particular for the displacement of a cursor over a screen of an electronic apparatus of the type in which the generator of control signals comprises:
a mobile contact rod which, in its rest position towards which it is elastically restored, lies along a substantially vertical direction in which a lower span of the rod is received with play between two opposed lateral lower contact elements, and which is mounted to tilt about a horizontal axis parallel to the axis of the associated coding shaft;
and a toothed pinion, tied in rotation to the associated coding shaft, between two consecutive teeth of which is received an upper span of the mobile contact rod in the rest position, in such a way as to cause the tilting of the contact rod, in one direction or the other, when the associated coding shaft is driven in rotation so as to establish electrical contact between the lower span and one or other of the two fixed contact lugs, and cause the automatic escapement of the upper span from the space delimited by the two consecutive teeth beyond a specified angle of rotation of the associated coding shaft.

The mobile contact rod is tied in rotation to the last turn of a first axial end of a spiral torsion spring, made of metal wire and of horizontal axis, the cylindrical body of which is accommodated in the housing and the second axial end of which is immobilized in rotation in such a way that the mobile contact rod is mounted to tilt about a horizontal axis parallel to the axis of the associated coding shaft.

According to the design proposed in this document, the upper span of the mobile contact rod is a 180° bent span which joins the mobile contact rod to the last turn of the first axial end of the spring and which lies in a vertical plane parallel to the axis of the spiral spring and substantially tangential to the periphery of the body of the spring.

The second end of the spring is blocked in rotation by its last turn which extends via a strand of axial orientation which itself extends via a free end strand which is of semicircular shape lying in a downwards vertical plane in such a way as to be received vertically in a complementary slot which is formed in the lower part of the housing and open vertical towards the top.

Each lateral lower contact element is a fixed contact lug of vertical orientation.

The contact lug can consist of a conducting lug belonging to a span of a flat flex cable which lies along a block of insulating material of the housing. It can also consist of a metal fixed contact around which the insulating material block is overmolded. Ball-type coding devices such as this are particularly compact and high-performance, and the present invention is aimed at improving certain aspects thereof.

The design of each coding spring affording several functions is indeed complex, thereby entailing a relatively lengthy forming cycle time, in particular so as to guarantee good parallelism between the plane of the fixed loop for rotationally immobilizing the spring and the plane of the mobile loop comprising the mobile contact rod.

In a prior solution, any defect of parallelism between the planes of the fixed and mobile loops gives rise to a defect of positioning in the rest state of the mobile contact rod with respect to a vertical plane of the housing, a recess of which receives the fixed loop.

The invention is aimed in particular at proposing a new design for the rotational immobilizing of the coding spring about its axis.

With this aim, the invention proposes a control device of the abovementioned type in which the mobile contact rod is tied in rotation to the last turn of a first axial end of a torsional spiral spring, made of metal wire and of horizontal axis, the cylindrical body of which is accommodated in the housing and the second axial end of which is immobilized in rotation in such a way that the mobile contact rod is mounted to tilt about a horizontal axis parallel to the axis of the associated coding shaft, characterized in that the span of second axial end of the spring is accommodated in a duct of the housing with at least one turn of this span which is thermowelded into the concave wall of the duct so as to immobilize it in rotation.

According to other characteristics of the device according to the invention:
the thermowelding operation is carried out by heating the said turns;
the turns are heated by Joule effect by passing an electric current through the said turns;
the duct is of semicylindrical shape, the open face of which is oriented vertically upwards, and in the course of the thermowelding operation, a downwardly oriented vertical load is applied to the turns of the spring;
the load is applied to the turns to be welded by means of two electrodes for heating the said turns which are applied to the axial end turns of the group of thermowelded turns in the concave wall of the duct;
the device comprises a fixed conducting contact lug which is arranged in a portion of the concave wall of the duct, opposite at least one of the said thermowelded turns;
this fixed conducting contact lug belongs to the upper face of an end of a flat flex cable received in the housing;
each of the two opposed lateral lower contact elements is a straight rod which lies horizontally parallel to the axis of tilting of the mobile contact rod, which is built into the housing, and a free end span of which lies opposite the lower span of the mobile contact rod and is elastically deformable in the horizontal plane;
the lower span of the mobile contact rod and the free end span of the fixed contact rod are two spans of cylindrical rod;
the end of each fixed contact rod, opposite its free contact end span is a linking strand which is in contact with a fixed conducting contact lug arranged in a wall of the housing;
the said fixed conducting contact lug belongs to the upper face of an end of a flat flex cable received in the housing;
the mobile contact rod is made in one piece with the spiral spring;
the signals generator comprises a toothed pinion, tied in rotation to the associated coding shaft, between two consecutive teeth of which is received an upper span of the mobile contact rod in the rest position, in such a way as to cause the tilting of the contact rod, in one direction or the other, when the associated coding shaft is driven in rotation so as to establish electrical contact between the lower span of the mobile contact rod and one or other of the two opposed lateral lower contact elements, and cause the automatic escapement of the upper span from the space delimited by the two consecutive teeth beyond a specified angle of rotation of the coding shaft;
it comprises two orthogonal revolving coding shafts driven in rotation, each in both directions, by a trackball mounted rotatably in the housing, each shaft being tied in rotation to a mobile coding element belonging to a generator of control signals;
the torsion spring is made of wire and in its external diameter is equal to the diameter of the wire, so as to constitute a torsion bar spring.

The invention also proposes a process for fixing a metal element, made of a conducting material, in a plastic body of an electrical and/or electronic component of the type in which at least one span of the metal element is accommodated in a duct of the body, characterized in that the said at least one span is fixed by thermowelding into the concave wall of the duct.

According to other characteristics of the process:
the thermowelding operation is carried out by heating the said span of the metal element;
the said span of the metal element is heated by Joule effect by passing an electric current through the span;
the duct comprises an open face which is oriented vertically upwards, and, in the course of the thermowelding operation, a downwardly oriented vertical load is applied to the said span of the metal element;
the said load is applied by means of two electrodes for heating the said span which are applied to the ends of the said span of the metal element fixed by thermowelding into the concave wall of the duct.

Other characteristics and advantages of the invention will become apparent on reading the derailed description which follows for the understanding of which reference may be made to the appended drawings, in which:

### BRIEF DESCRIPTION OF THE DRAWINGS

FIG. 1 is a top isometric view, of a control device in accordance with the teachings of the invention with its connection to a flat flex cable;

FIG. 2 is an exploded isometric view of the various components of the device of FIG. 1;

FIG. 3 is a plan view of the lower part of the bare housing of the device of FIGS. 1 and 2;

FIGS. 4 to 6, 7A, 7B and 8 are sectional views of the device according to the invention, through the vertical sectional planes 4-4 to 8-8 indicated in FIG. 3 and in which the contact rods are represented in their stable vertical rest position, except in FIGS. 7A and 7B in which the contact rod is represented in the two opposed contact positions;

FIG. 9 is a plan view which illustrates the various conducting contact lugs of the end span of the flat flexible cable which is received in the bottom of the housing;

FIGS. 10 to 13 are views similar to that of FIG. 3 which illustrates various steps of placing the components in the lower part of the housing;

FIGS. 14 to 16 are isometric views corresponding to the views of FIGS. 10, 11 and 13;

FIG. 17 is a three-quarter rear isometric view from above and the right of the lower part of the housing;

FIG. 18 is an isometric view from beneath of the upper part forming a cover of the housing;

FIG. 19 is an isometric view on a large scale, which illustrates a coding spring according to the invention;

FIG. 20 is an isometric view on a large scale, which illustrates a fixed contact rod according to the invention;

FIG. 21 is an isometric view similar to that of FIG. 1 which illustrates a variant embodiment of the invention in which the linking flat flexible cable is replaced by connection tabs around which the lower part of the housing is overmolded;

FIG. 22 is a view similar to that of FIG. 3 which illustrates the lower part of the housing of the device of FIG. 21;

FIGS. 23 and 24 are views similar to those of FIGS. 3 and 4 and which represent a device according to another embodiment of the invention.

### DESCRIPTION OF THE PREFERRED EMBODIMENT

Limited Description of the Invention

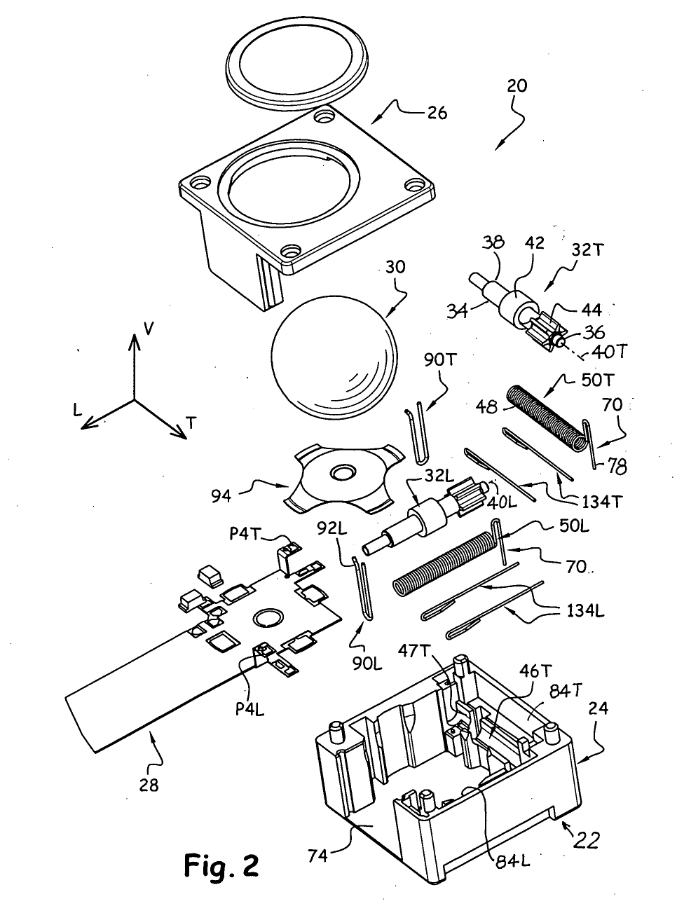

FIG. 2 shows that the control device 20 includes a trackball 30 that lies in a housing 22. An upper portion of the trackball projects up though a hole in a housing upper part 26. The control device also includes two coding shafts 32L and 32T that are rotatably mounted in the housing to rotate about orthogonal (perpendicular) axes including axis 40T (which is parallel to direction arrow T) and 40L (parallel to direction arrow L). Each shaft has a roller 42 and pinion 44, each fixed to the shaft. Each roller is engaged with the trackball so when the trackball turns one or both rollers will turn.

The turning of a coding shaft is detected by a contact rod 70 of a corresponding one of two springs 50L, 50T. The upper end of each contact rod lies between teeth of the pinion 44. When a coding shaft and its pinion turns, the upper end of the contact rod is repeatedly deflected and released, and the contact rod pivots back and fourth. The lower end of the contact rod at its lower span 78 then repeatedly engages and disengages one terminal pin of a pair of terminal pins 134L or 134T. Electricity passes though one of the springs 50T or 50L and though one of the terminal pins 134L, 134T to complete a circuit.

In this description a part such as contact rod 70 will sometimes be referred to as 70L or 70T to show the element to which it belongs.

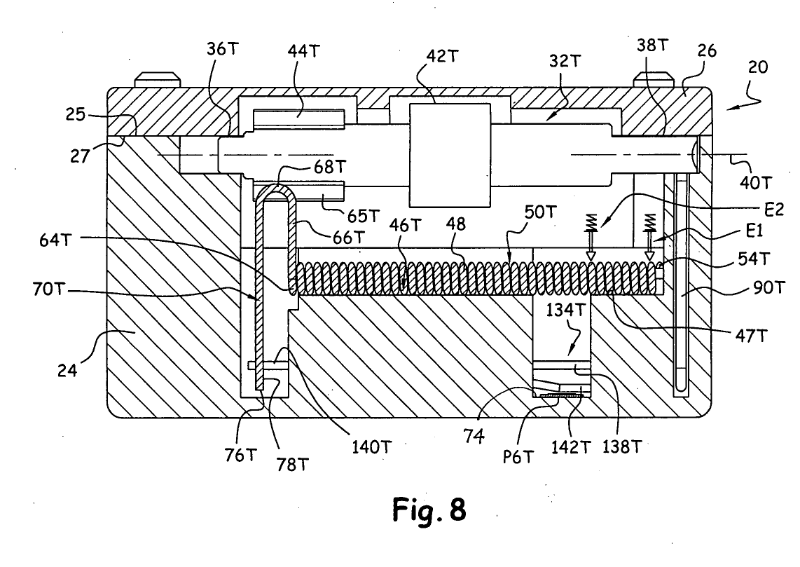

Each spring has a main portion that lies in a spring recess such as 46T of the housing. FIG. 8 shows that the spring 50T has a main portion 48 wherein wire of the spring extends in a helix to form a torsion spring. A far end portion 47T of the torsion spring is fixed to the walls of the spring recess. Such fixing is accomplished by resistance heating of the spring far end portion to melt plastic of the housing around a side of one or more spring turns. Such heating is accomplished by electrodes E1, E2 that press down the spring far end portion while passing current through it. In use, the far end portion 47T of the spring is connected to an electrical terminal. The near end of the spring has an upward strand 66T, an approximately 180° bend 68T, and a downward strand 78T. The two strands 66T, 78T and the bend 68T form the contact rod 70T. The contact rod intermittently engages a cantilevered strand 140T of a terminal pin 134T which is connected to another electrical terminal P6T.

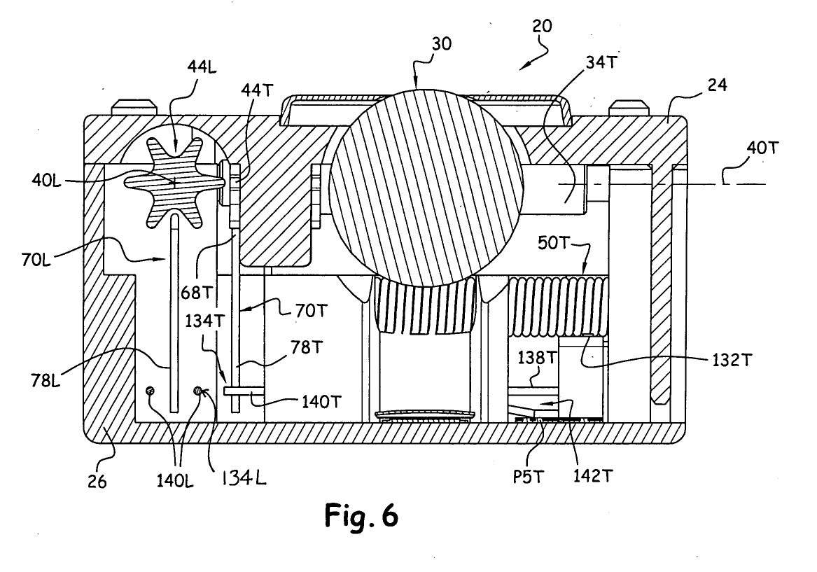

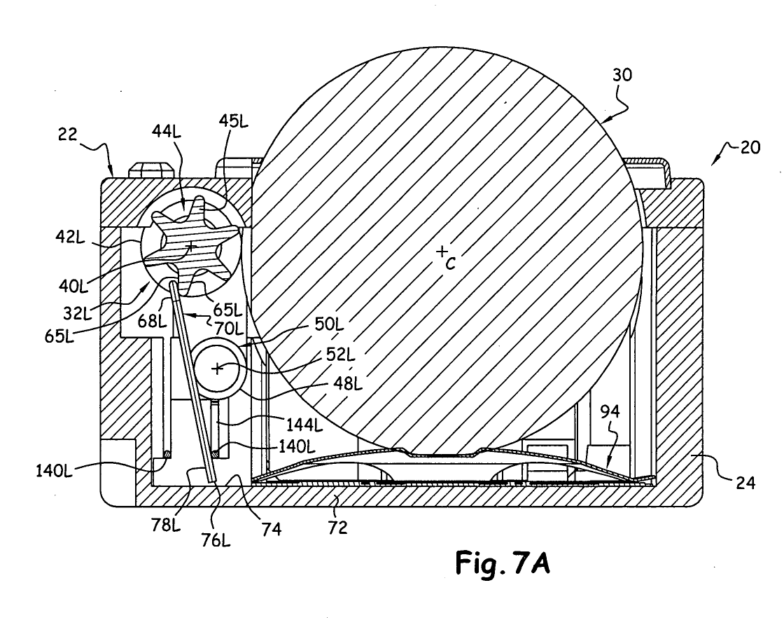

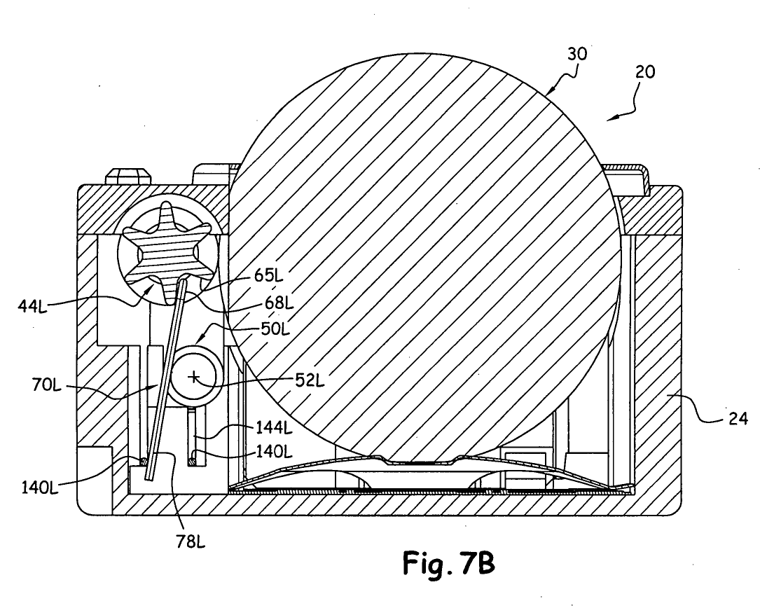

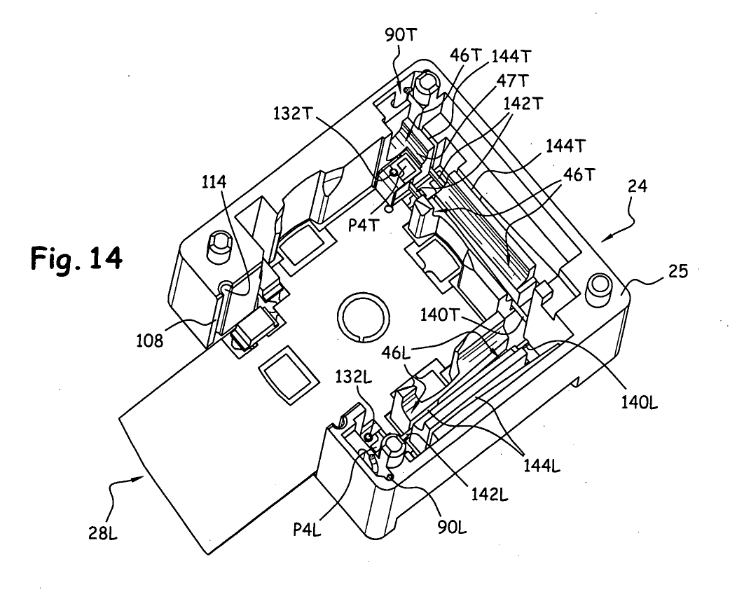

The contact rod initially assumes the undeflected, or untilted or released position of FIG. 6 wherein the contact rod 70L is shown with pinion-engaging part formed by its upper end, at its bend, lying between a pair of teeth of the pinion 44L. The lower end of the rod is out of engagement with the contact spans 140L of two terminal pins 134L. FIG. 7A shows the contact rod 70L in its deflected, or tilted position wherein it has been deflected by clockwise turning of the pinion 44L and a pinion tooth has almost lost engagement with the rod. The contact rod has been tilted sufficiently about the spring axis 52L, that the contact rod lower span 78L engages a free contact span 140L of a terminal pin 130L. Electricity then can pass though the spring and its contact rod 70L, and through the terminal pin 130L to complete a circuit. The far end of the spring presses against a conductive lug P4L or P4T (FIG. 14) of a flat flexible circuit board, or flex cable. The terminal pin has a looped part 142L, T (FIG. 20) with a lower side that engages a conductive lug (P5T in FIG. 6, and P6T in FIG. 8) of the same flex cable.

When the pinion turns in the opposite direction, such as counterclockwise in FIG. 7B, the contact rod 70L rotatably deflects in the opposite direction. Then the bottom 78L of the contact rod repeatedly engages and disengages a contact span 140L of a second terminal pin. The particular terminal pin that is repeatedly engaged indicates the direction of turning of the track ball, and the number of times that the contact rod engages and disengages a pin terminal indicates the angle that the track ball has turned.

FIG. 14 shows that the housing has slots such as 144L that receive the terminal pins, with the looped end 142L pressed down by the housing and with the contact span 140L cantilevered. The cantilevered span can resiliently bend when the lower span 70T (FIG. 8) of the contact rod presses against it. The lower span of the contact rod also can resiliently bend.

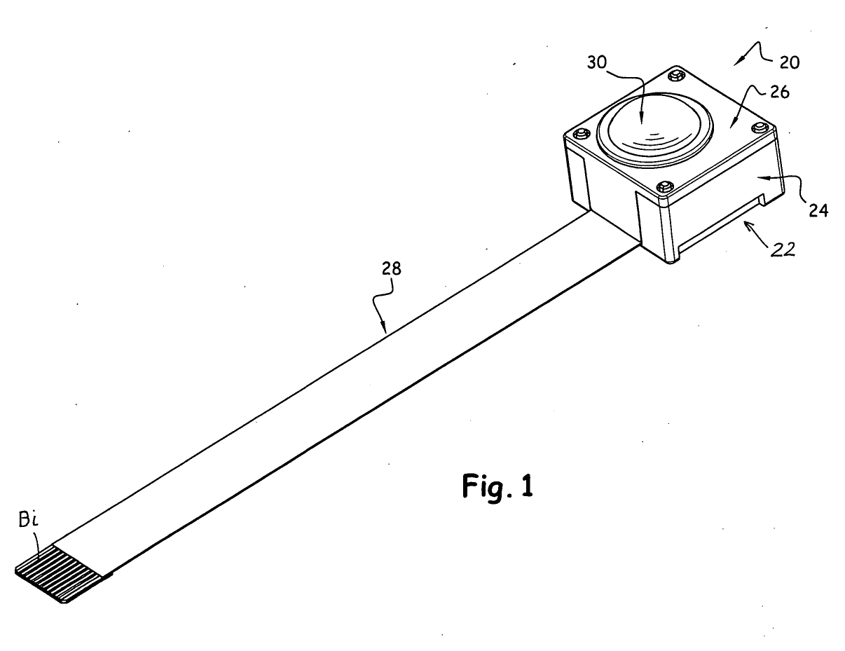

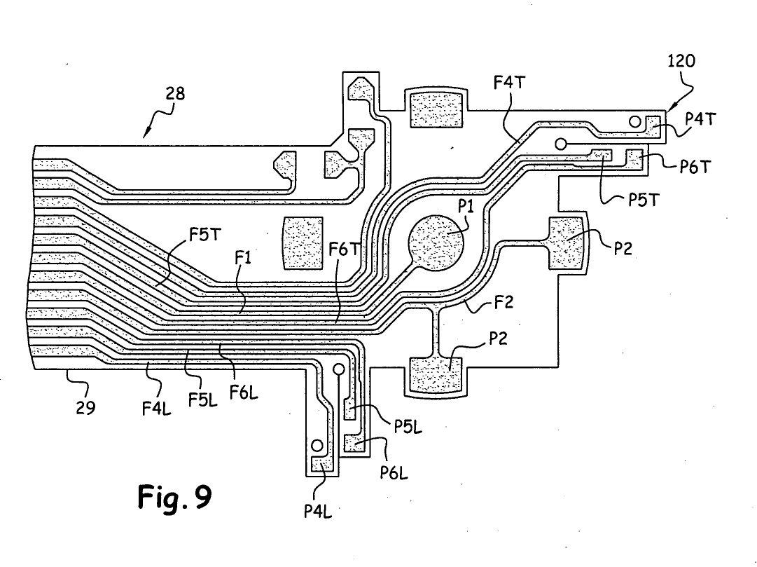

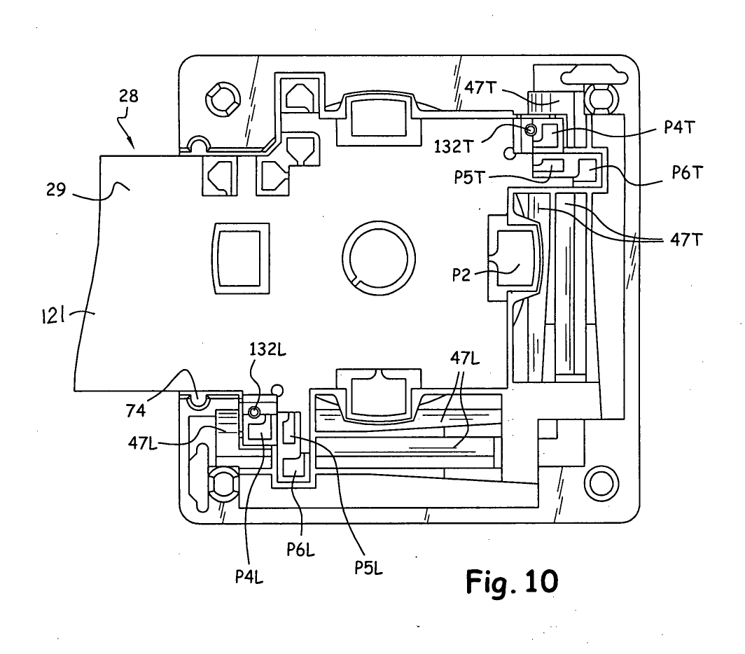

FIG. 1 shows that connections to the control device are made though the flat flexible circuit board, or flex cable 28. FIG. 9 shows the flex cable without an insulative covering, while FIG. 10 shows the cable end portion lying in the housing and with an insulative covering . The flex cable has numerous conductive pads or lugs that are engaged by parts of the device.

While terms such as “top”, “bottom”, etc. have been used to describe the control device as illustrated, the control device can be used in any orientation.

More Complete Description of the Invention

For the description of the invention, we shall in a nonlimiting manner adopt the vertical, longitudinal and transverse orientations according to the V, L, T reference frame indicated in FIG. 1.

By convention, we shall also adopt the terms lower, upper, front, rear, and left, right with reference to FIG. 1.

In the description which follows, identical, similar or analogous elements belonging to the embodiments according to the invention or according to the state of the art will be designated by the same numerical or alphanumerical references.

The first part of the description will describe chiefly the elements common to the embodiments of the invention.

The device 20 (FIG. 1) comprises a housing 22 of substantially right-angled parallelepipedal general shape made of two parts, the main lower part 24 and the upper part 26 forming a cover for closing the lower part which accommodates the main components of the device 20.

The device essentially comprises a central trackball or sphere 30 which drives in rotation, here by friction, two orthogonal coding shafts 32T, 32L, each of which is part of a signal generator.

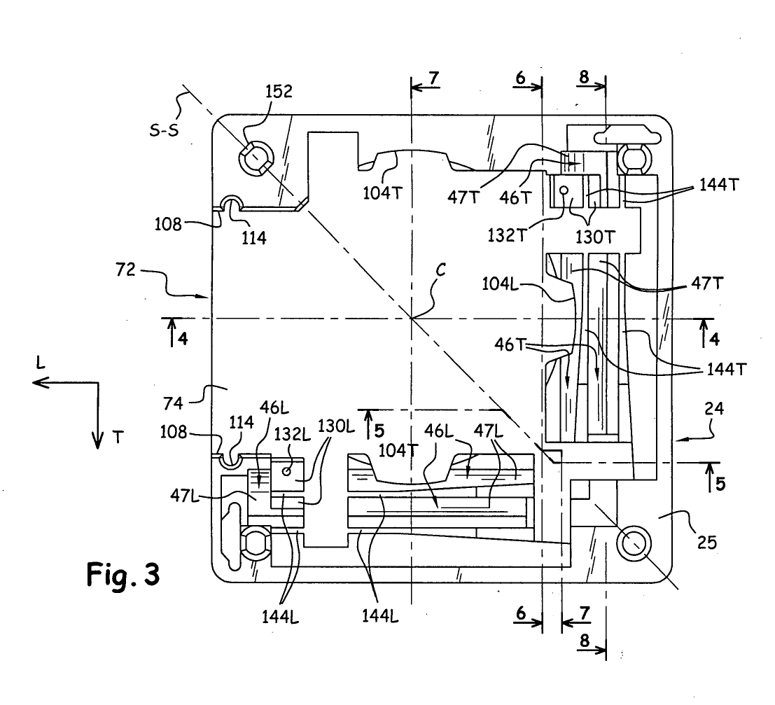

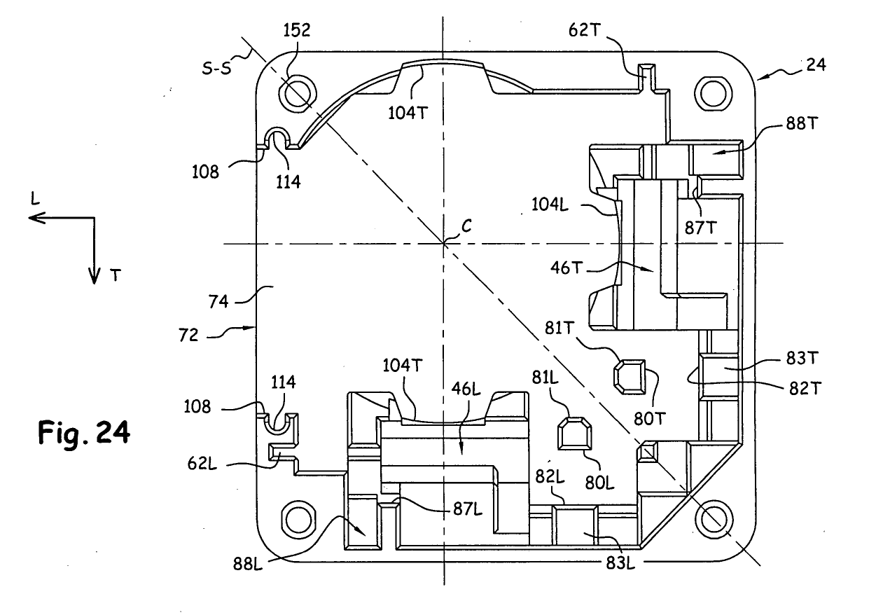

The two shafts and the signal generators are of the same construction and of overall symmetric design, and arranged symmetrically, with respect to a vertical plane of symmetry corresponding to the line S-S of FIGS. 3 and 24 and in which the center C of the ball 30 lies.

Thus the identical, similar or analogous elements associated with the coding shaft of longitudinal axis and with the coding shaft of transverse axis will be designated by the same reference numerals indexed “L” and “T” respectively.

Each coding shaft 32L, 32T (FIG. 2) comprises a stepped cylindrical body 34 whose two opposite free ends 36 of small diameter and 38 of large diameter are mounted so as to rotate in both directions in the housing 22 about an axis 40L, 40T of rotation.

Each body 34 comprises a drive drum or roller 42 whose peripheral surface cooperates by friction with that of the ball 30, and a toothed coding pinion 44 which are fixed to the shaft.

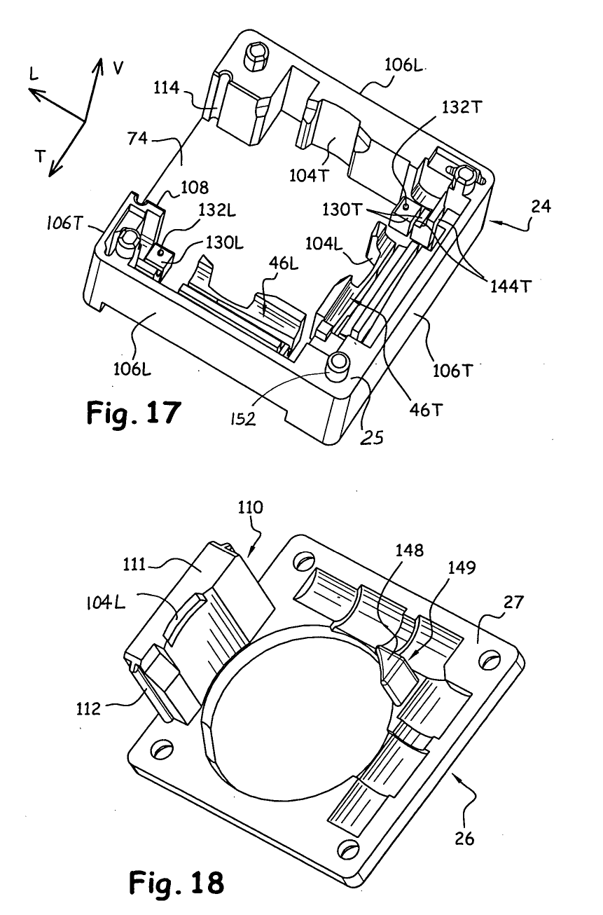

Beneath each coding shaft 32L, 32T, the lower part 24 of the housing 22 comprises a recess of semicylindrical general duct 15 shape 46L, 46T open towards the top (see FIGS. 17 and 18).

Each recess 46L, 46T receives the cylindrical main body 48L, 48T of a torsional spiral spring 50L, 50T made of metallic wire wound around an axis 52L, 52T.

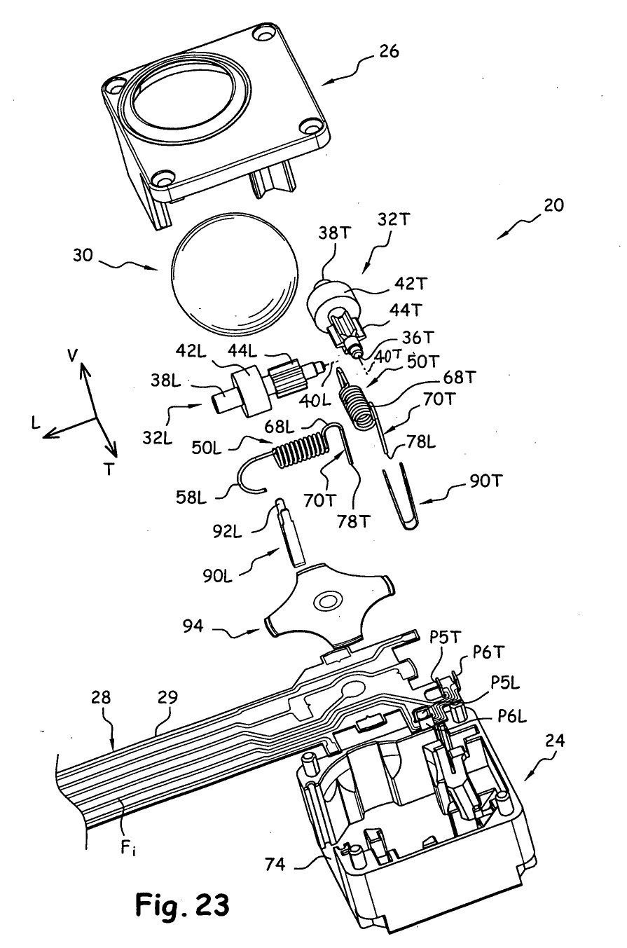

In the embodiment of FIG. 23, the last turn of each spring is extended by a strand of axial orientation, along the axis, which is itself extended by a free end strand 58L, 58T which is of semicircular shape extending downwards in a vertical plane in such a way as to be received vertically in a complementary slot 62L, 62T which is formed in the lower part 24 of the housing and open vertically towards the top. The strands 58L and 58T in place in their associated slot 62L, 62T, bear vertically downwards against opposing lugs P4L and P4T of the flex cable.

The spring of FIG. 8 has a first turn 64L, 64T, axially opposite the last turn 54L, 54T, which is extended upwards by a vertical strand 66L, 66T which joins the first turn to a vertical mobile contact rod 70L, 70T by way of a 180° bent upper strand 68L, 68T.

Thus, the shaping of this end of each spring is such that the joining strand 66L, 66T, the contact rod 70L, 70T and the bent strand 68L, 68T (which constitutes the upper end span of the contact rod) lie in a vertical plane substantially tangential to the periphery of the cylindrical body 48L, 48T of the spring 50L, 50T.

The vertical orientation of the contact rod 70L, 70T, in the rest position results from the design of each spring 50L, 50T with its contact rod 70L, 70T and its bent strand 58L, 58T, the latter being guided vertically in the slot 62L, 62T in such a way as to position the spring 50L, 50T angularly and to rotationally immobilize its end comprising the turn 54L, 54T.

The lower part 24 (FIG. 2) of the housing 22 is of hollow right-angled parallelepipedal general shape and it has a bottom with a horizontal plane upper face 74.

The height of each vertical contact rod 70L, 70T (FIG. 8) is such that the free end 76L, 76T of its lower contact span 78L, 78T extends with play above the portion overlooking the upper face 74.

Each lower contact span 78L, 78T is also received with lateral play between two vertical abutment surfaces 80L, 80T and 82L, 82T (FIG. 24) which belong to blocks of material 81L, 81T and 83L, 83T made integrally by molding with the bottom 72 and which project vertically upwards.

As a function of the rotation of the ball 30, each control rod 70L, 70T is capable of tilting with respect to its vertical position with a corresponding displacement of the lower contact span 78L, 78T towards the abutment faces 80L-82L, 80T-82T.

For the rotational mounting of each coding shaft 32L, 32T, the lower part 24 of the housing 22 comprises, in proximity to its horizontal upper face 25, recesses open vertically towards the top, 84L, 84T and 86L, 86T, which respectively receive the free ends 36L, 36T and 38L, 38T of the body 34L, 34T of each coding shaft 32L, 32T.

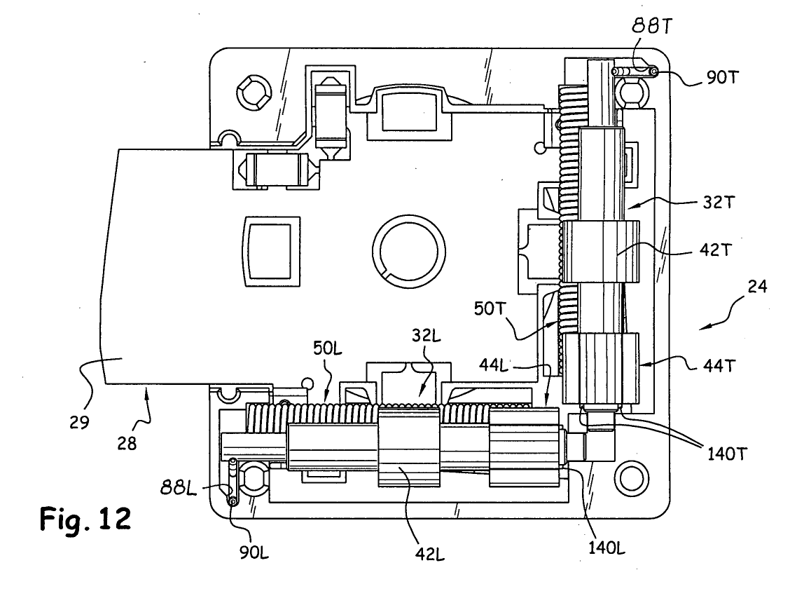

The horizontal width of the recesses 84L, 84T is substantially equal to the diameter of the end pivots 36L, 36T while the recesses 86L, 86T are open laterally towards the inside of the housing, each recess being supplemented with an elastic pin in the shape of a hairpin 90L, 90T which is mounted vertically in a complementary recess 88L, 88T (FIG. 12) in such a way that the free end upper branch 92L, 92T of the pin pointing towards the inside of the housing urges the corresponding pivot 38 elastically so as to push the roller 42 against the ball 30.

The device 20 also comprises an entry switch which consists in essence of an elastic triggering member 94 (FIG. 2) of the monostable type, of known general design in the shape of a star with four branches.

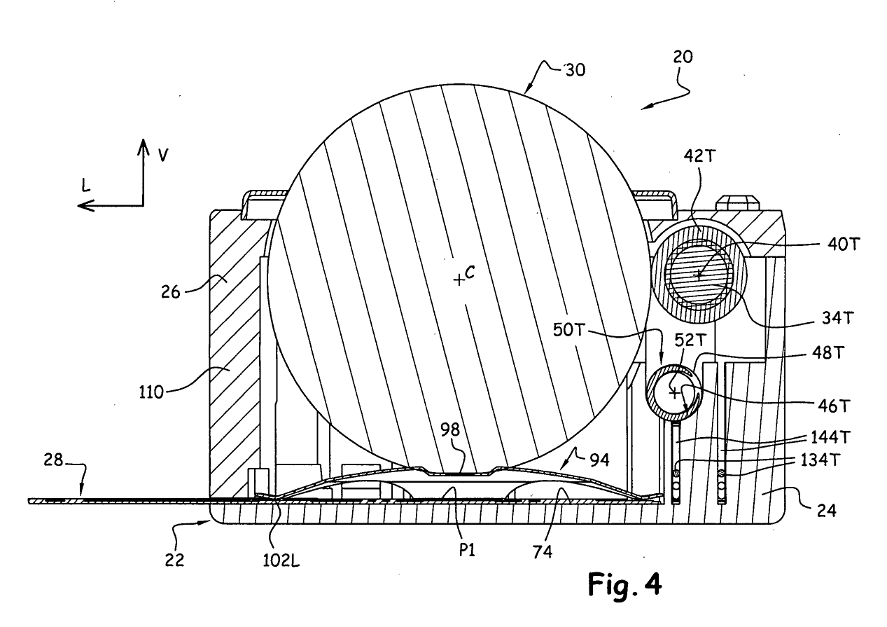

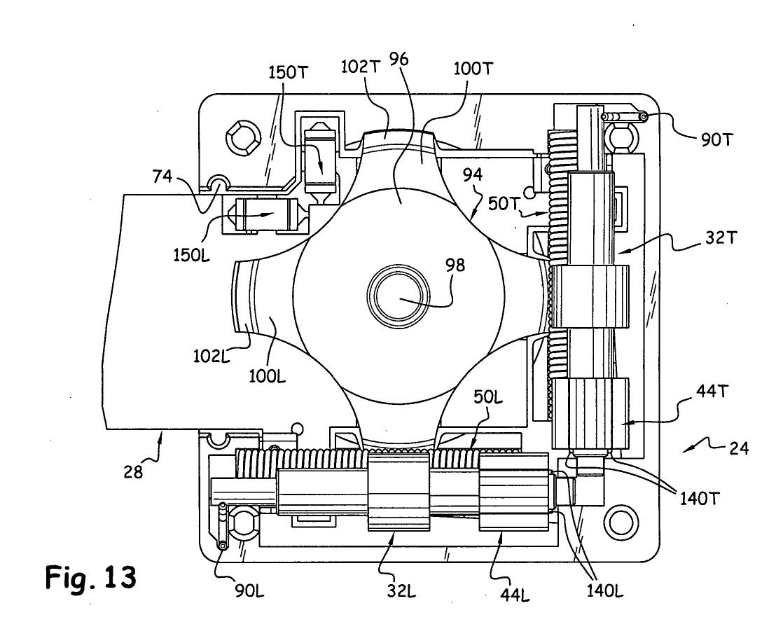

The triggering member 94 (FIG. 13) comprises a central part 96 comprising a dish in the shape of a spherical cap 98 with its concavity oriented upwards (FIG. 4) on which the trackball 30 bears, and comprises two pairs of radial branches 100L, 100T, distributed at 90°, each of which terminates in a lower bearing and contact edge in the form of an arc of a circle 102L, 102T with its convexity oriented downwards.

The angular positioning of the triggering member 94 in the lower part 24 of the housing is ensured by means of the pair of recesses 104T (FIG. 3) which receive the two end edges 102T, and by means of a third recess 104L which receives one of the two end edges 102L, while the other edge 102L is received in a last recess 104L formed in the cover (see FIG. 18).

As may be seen in particular in FIG. 17, the lower part 24 of the housing 22 has two parallel and opposite lateral walls 106L, left and right, and a rear transverse wall 106T of transverse orientation, while the front transverse wall 106T comprises, over its entire height and as far as the upper face 74 of the bottom 72, an opening 108 whose function will be explained subsequently.

The cover 26, illustrated in particular in FIG. 18, consists in essence of a horizontal board whose lower face 27 is designed to bear on the upper face 25 of the lower part 24.

The lower face 27 comprises cylindrical arc-shaped indentations to allow free passage and rotation of the rollers 42 and of the pinions 44.

The cover 26 also comprises a vertical partition 110 complementary to the opening 108 (FIG. 17) of the lower part 24 which comprises, along its vertical edges, two ribs 112 complementary to the grooves 114 formed in the edges of the opening 108 in such a way as to allow the cover 26 to be mounted slidably, vertically downwards, on the lower part 24.

In the assembled position, and as will be seen for example in FIGS. 1 and 23, the cover 26 thus completes and fully closes the housing 22.

The electrical linking of the control device 20 is ensured by means of a flat flexible cord or cable 28, also known as a flex cable, whose design and technology are known.

The height of the partition 110 (FIG. 18), delimited vertically towards the base by its horizontal edge 111, is sightly less than the height of the opening 108 (FIG. 17) in such a way as to allow the passage of the body 29 (FIG. 23) of the flex cable 28.

In all the figures, except FIG. 9, the upper face of the flex cable is represented without the insulating upper layer (121, FIG. 10) applied to the conducting tracks of the flex cable joining the lugs Pi and the terminals Bi. This layer, or “cover layer”, makes it possible to guarantee electrical insulation between the tracks and to eliminate the risks of short-circuits during entry via deflection of the dome 94.

The flex cable 28 thus comprises a body in the shape of a band 29 (FIG. 9) of small thickness, of the order of 0.12 mm, inside which are made conducting wires or lines.

The rear free end span 120, on the right when considering for example FIG. 9, comprises, made integrally, a series of conducting pads or lugs Pi joined to the wires Fi each of which constitutes a fixed contact intended to cooperate with the various active elements. 25 The contour of this rear span 120 exhibits a cutaway profile allowing its placement inside the housing lower part 24 (FIG. 17) so as to bear horizontally on the upper face 74 of the bottom 72.

To make the entry switch, in association with the triggering member 94, the upper face 122 of the rear span 120 comprises a central conducting lug P1 in the form of an inset, joined to a wire F1, which is situated vertically plumb with the central part 98, and two lugs P2, joined together and to a wire F2, which are situated longitudinally on either side of the central lug P1 and on each of which bears a lower contact edge 102L of the triggering member 94.

Conducting lugs are also provided for the transmission of the coding signals produced by the signal generators associated with the contact shafts 32L and 32T.

The body of each spring 50L, 50T is joined to a wire F4L, F4T, by way of a lug P4L, 25 P4T, on which the free end 60L, 60T of the corresponding bent arm 58L, 58T bears elastically.

Thus, each mobile contact rod 70L, 70T is joined, via the body 48L, 48T of the spring 50L, 50T, to a conducting lug P4L, P4T, and hence to a corresponding wire F4L, F4T.

The lower contact span 78L, 78T (FIG. 7A) of each mobile contact rod 70L, 70T is received between two opposite contact lugs (FIG. 9) P5L, P5T and P6L, P6T of vertical orientation which are made by cutting out from the span 120 of the flex cable 28 and which, after mounting, are stood upright in vertical planes while bearing against the vertical surfaces of corresponding abutments 50L, 80T and 82L, 82T (FIG. 24).

By placing the span 120 of the flex cable 28 in position in the bottom 72, 74 of the lower part 24 of the housing 22, the various fixed contacts consisting of the conducting lugs Pi are made, while the part of the flex cable 28, 29 which exits the housing 22 via the opening 108 (FIG. 17) is pinched by the lower edge 111 of the partition 110.

The manner of operation of the signal generators will now be described.

This description will be given with reference to the coding shaft 32L, the manner of operation of the other shaft being analogous insofar as all its components are identical, with the exception of the spring 50T which, for load balancing reasons, is of symmetric design with respect to the vertical plane S-S.

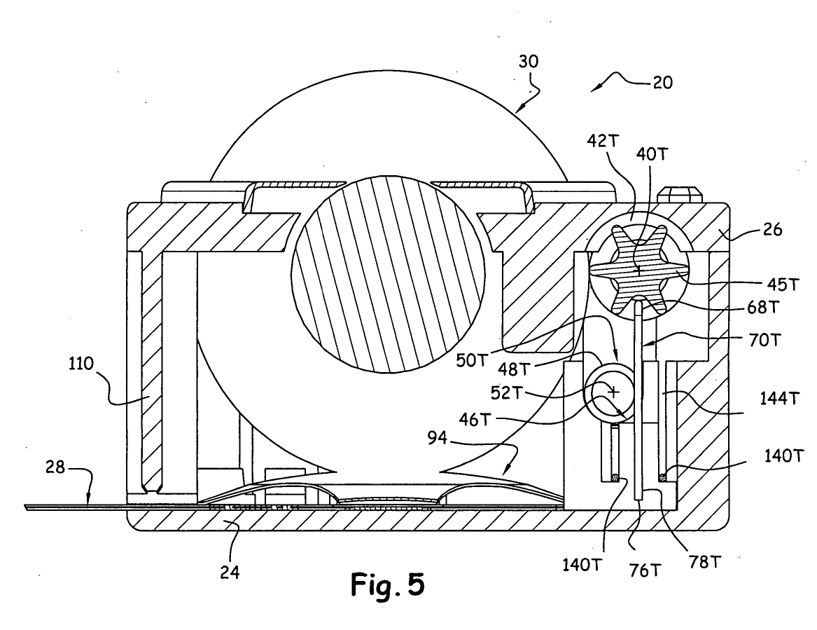

In the rest position represented in FIGS. 4 to 6, the mobile contact rod 70L is vertical and its bent upper span 68L is received, with lateral play along the direction T, between the opposing flanks 45L of two consecutive teeth of the coding pinion 44L.

By causing a rotation of the ball 30 about its center C, and here about a horizontal axis of longitudinal orientation, a rotation of the shaft 32L is caused about its axis of rotation 40L.

This rotation causes the contacting of the flank 45L of the right-hand tooth which will then push the upper span 68L transversely, from right to left.

By virtue of the possibility of torsional elastic deformation of the body 48L of the spring 50L to which the rod 70L is tied and which functions as restoring spring for returning the rod 70L to its rest position, the latter tilts overall about the axis 52L until its lower contact span 78L comes into electrical contact against the lug P5L, and into abutment against the abutment surface 80L (FIG. 24) across the flex cable, thus establishing an electrical link between the lugs P4L and P5L.

The clockwise rotation of the roller 32L continues and this rotation causes, in the manner of a mechanism of the “Maltese Cross” type, the automatic escapement of the upper span 68L (FIG. 7) which continues its tilting movement so as subsequently to automatically return, together with the contact rod 70L, to its stable vertical rest position.

If the rotational movement of the ball 30 is continued in the same direction, the rod 70L will again tilt with the same orientation represented in FIG. 7B so as to cause the generation of a new signal by virtue of the electrical contact which is again established between the lugs P5L and P4L.

Conversely, if the ball 30 is driven in rotation in the other direction and the tooth 45L causes the tilting of the contact rod 70L until its lower contact span 78 comes into contact against the conducting lug P6L and into abutment against the vertical surface 82L.

This coming into contact then establishes an electrical contact between the lugs P6L and P4L, generating a signal which is different from that resulting from the linking across the spring 50L of the lugs P5L and P4L.

This differentiation of the two types of signals, established between P4L and P5L or P4L and P6L, makes it possible to distinguish the direction of rotation of the relevant coding shaft, and hence the direction of rotation of the ball, doing so by means of a single mobile contact, 70L or 70T, for each signal generator.

Of course, depending on the type of manipulation applied to the ball 30 by the user, the latter can cause the simultaneous rotation of both coding shafts 32L and 32T in one or other of their opposite directions of rotation.

The ball practically always revolves about a horizontal axis. and. as a function of the orientation of the plane of rotation of the ball, the numbers of pulses generated by the two generators are respectively proportional to the X and Y components of investigation of the cursor on the screen.

The driving of the rollers 42L, 42T carried by the shafts 32L, 32T is ensured by friction with the outer surface of the trackball 30.

The shafts together with the rollers are urged under elastic hearing against the ball by the hairpin springs 90L-92L and 90T-92T (FIG. 12).

Entry is effected by applying to the trackball 30 a vertical load F oriented globally in the direction parallel to the direction V.

This action has the effect of causing its downwards vertical displacement with respect to the lower part 24 of the housing and of causing a change of state of the monostable triggering member 94 until its central part 98 (FIG. 4) comes into contact with the conducting lug P1, thus causing electrical linking between the lugs P1 and P2 and hence between the wires F1 and F2, while affording the user a tactile sensation of actuation of the entry switch.

Owing to the positioning of the center C (FIG. 4) of the ball 30 beneath the plane of the axes 40L and 40T of the order of 0.1 mm, the entry action tends to “detach” the ball 30 from the rollers 42L, 42T and it thus has no nuisance effect on the rollers 42L and 42T, nor therefore on the generators of coded signals which remain in their states corresponding to their angular positions attained at the moment of entry.

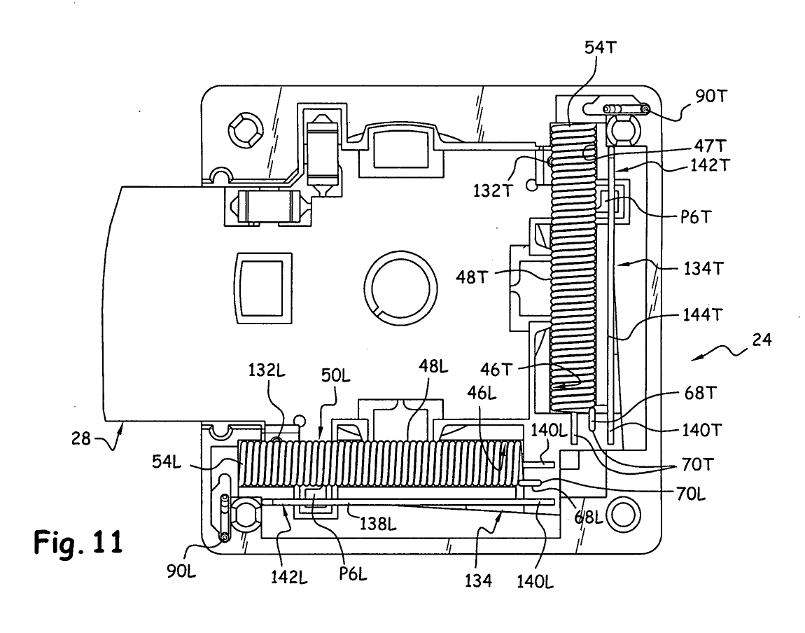

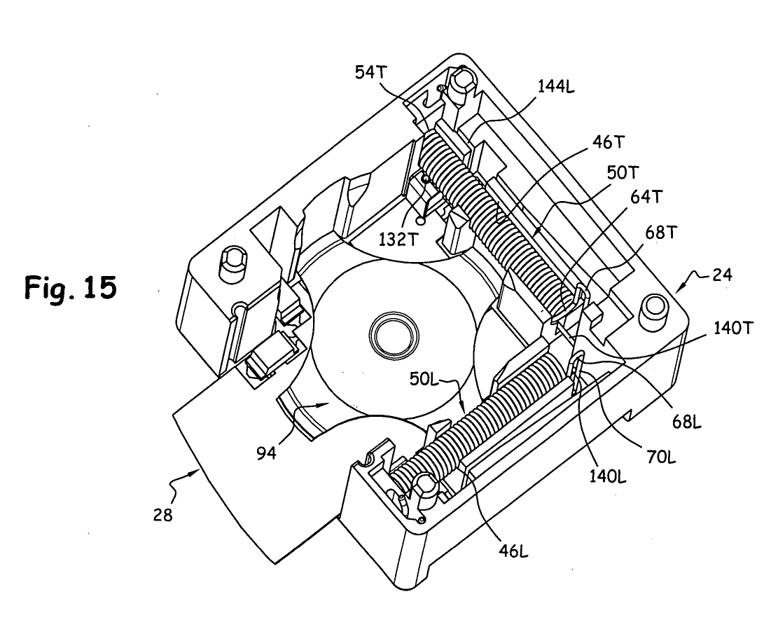

Various steps of assembling the components of the device 20 may be seen in succession in FIGS. 3 and 10 to 16, before the mounting of the cover 26.

The positional holding of the span 120 of the flex cable 28 in the bottom 72, 74 of the lower part 24 of the housing 22 is ensured through the contact pressure of the four edges 142L and 142T of the member 94 and, according to the state of the art, of the strands 58L and 58T (FIG. 23) of the springs 50L and 50T. Moreover, the lower face 148 (FIG. 18) of a central foot 149 of the cover 26 pinches a facing part of the flex cable after hot-crimping of the studs 152 (FIG. 17) for mounting and fixing the cover 26 onto the part 24.

This pinching is compounded with that by the lower edge 11 of the partition 110 of the cover which can be completed with complementary shapes (not represented) such as bumps and/or complementary hollows, formed in the edge 111 and/or in the facing part of the facing bottom 74.

The various aspects of the invention will now be described in particular.

Overall, each spring 50, 50T is simplified by eliminating the loop-shaped free end strand 58L, 58T (FIG. 23) which served previously for its rotational immobilization, for the angular positioning of the mobile contact rod 70L, 70T and for the electrical linking of the spring.

The lower part 24 is simplified to the same extent.

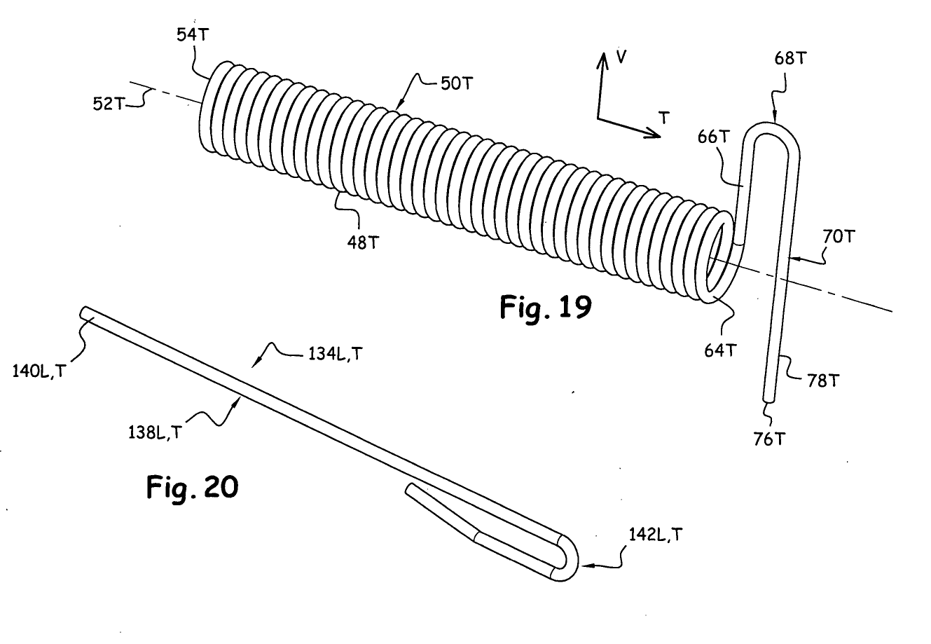

In accordance with the invention, in order to afford the functions previously fulfilled by the loops 58L, 58T, the second axial end of the spring 50L, 50T, comprising the last turn 54L, 54T (FIG. 19) is fixed by thermowelding of consecutive turns of this span, in the corresponding facing portions 47L, 47T (FIG. 8) of the duct 46L, 46T opposite which the relevant turns lie.

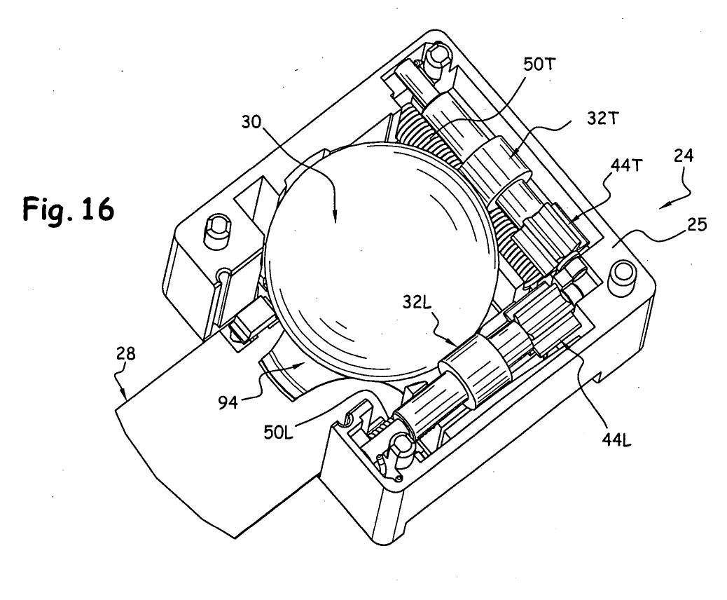

For example, it is possible to thermoweld the eight or nine end turns, on the right when considering FIG. 16, of the spring.

The thermowelding operation, represented diagrammatically in FIG. 8, is carried out by heating by Joule effect the corresponding span of the spring by means of two electrodes E1 and E2 which are applied to the corresponding end turns of the span to be fixed by thermowelding.

The passing of the current between the electrodes E1, E2 through the turns causes, by Joule effect, instantaneous heating of the corresponding wound metal wire span of the spring that constitutes the turns.

The two electrodes E1 and E2 moreover exert a bearing force directed vertically downwards on the span of the spring.

The heating obtained by Joule effect then causes localized melting of the concave wall 47L, 47T of the duct 46L, 46T.

Moreover, a “suction” and/or capillarity phenomenon occurs, by virtue of which the molding skin of the concave surface 47L, 47T of the plastic duct 46L, 46T hugs the entire external peripheral surface of the group of heated turns, while also lying between the heated turns.

After halting the passage of the current, cooling is rapid and the plastic, which has previously been melted, solidifies and hugs the periphery of the group of turns, with moreover excellent adherence.

The intensity of the current and the time for which it passes are chosen as a function of the ohmic resistance of the wire from which the spring 50L, 50T is made and of the melting temperature of the constituent plastic of the lower part 24 of the housing.

By way of example, the intensity is between 1A and 2A, and the heating time is of the order of a few tenths of a second.

Owing to the elastic deformation properties of the turns, each in its plane substantially perpendicular to the axis 52L, 52T of the body 48L, 48T, the application of the electrodes may cause a slight deformation of the turns, giving them an elliptical shape.

This deformation is advantageous since it increases the penetration of the corresponding parts of the turns into the local molten concave surface 47L, 47T of the duct.

To afford electrical linking of the body 48L, 48T of the spring 50L, 50T, the flex cable 29 comprises a conducting lug P4L, P4T which lies vertically above the plane of the bottom of the lower part 24 so as to be positioned opposite the surface 130L, 130T (FIG. 17) of a raised portion of the lower part 24 which is situated at the level of the concave bottom of the duct, and beneath the group of thermowelded turns.

During the thermowelding operation, the bearing force exerted vertically downwards by the two electrodes E1 and E2 applies the corresponding portions of the periphery of the turns against the conducting lug P4L, P4T (FIG. 10).

Owing to the elastic properties of the turns in a vertical plane perpendicular to the axis 52L, 52T, the bearing force of the group of turns on the conducting lug P4L, P4T, itself bearing on the surfaces 130L, 130T, is maintained after the end of the thermowelding operation, that is to say when the electrodes no longer exert any load on the spring.

To guarantee good positioning of the lugs P4L and P4T under the corresponding groups of turns to be thermowelded, the flex cable can comprise a positioning hole in which is inserted a stud 132L, 132T (FIG. 16) molded integrally with the lower part 24 of the housing.

The stud 132L, 132T can also be hot crimped so as to further improve the positional holding of the tag of the flex cable 29 which comprises the lug P4L, P4T.

The number of thermowelded turns depends on the value that one wishes to obtain for the stiffness of the torsional couple of the spring affording the function of restoring the mobile contact rod 70L, 70T to its vertical rest position, as well as the mechanical strength desired for the holding and the fixing of the thermowelded span of the spring 50L, 50T.

The vertical angular orientation of the mobile contact rod 70L, 70T of the spring is obtained by means of a jig, not represented, belonging to the tooling used for the thermowelding operation.

Each duct-shaped recess 46L, 46T is designed in such way as to avoid any radial clamping of the turns of the corresponding spring and there is thus no risk of inducing torsional stresses in the turns during the operations of placement and fixing of the spring by thermowelding.

Thus, after the operation of fixing the spring, there are no risks of spurious angular displacement of the mobile loop comprising the mobile contact rod when the jig is removed.

In the design illustrated in particular in FIGS. 23 and 24, the establishing of direct electrical contact between the lower end 76L, 76T of the mobile rod 70L, 70T on the fixed conducting lugs P5L, P5T and P6L, P61 induces certain stresses so as to guarantee good electrical performance, and to avoid overly large variations in the snap-fastening force with which the loop 68L, 68T is fitted into the pinion 44L, 44T.

It is, in particular, necessary to guarantee high accuracy in the length of the rod 70L, 70T, and perfect burr-free sectioning of the lower free end 76L, 76T.

Moreover, the establishing, repeated hundreds of thousands of times, of electrical contact between the sectioned edge of the lower end and the facing surface of the conducting lugs, might cause premature wear of the precious metal layer that covers these latter parts.

In order to remedy these drawbacks, the invention proposes a design aimed at producing a fixed electrical contact which is elastically deformable.

For this purpose, the lower span 78L, 78T (FIG. 2) of the mobile contact rod 70L, 70T is received between two parallel and opposed fixed horizontal contact rods or terminal pins 134L, 134T.

The two fixed contact rods 134L or 134T of a contact pair associated with a mobile rod 70L or 70T are identical.

Thus, the invention advantageously calls upon four identical rods.

As may be seen in FIG. 20, each fixed contact rod 134L 134T is made of bent metal wire and consists chiefly of a straight main body 138L, 138T which, at an axial end, terminates in a free end contact span 140L, 140T and, at its other end, in a hairpin loop 142L, 142T that lies in a vertical plane in which it is elastically deformable.

The body 138L, 138T and the loop 142L, 142T are received in corresponding vertical slots 144L, 144T (FIG. 7A) of the lower part 240 of the housing 22 which lie in vertical planes parallel to the axis of the corresponding contact spring.

Thus, each fixed contact rod 134L, 134T is built-in in the manner of a beam, with the exception of its free end contact span 140L, 140T which lies freely, each on either side of the vertical mobile contact rod 70L, 70T.

Each free end span 140L, 140T is thus free to deform elastically laterally in a horizontal plane, the two parallel and opposed rods of a fixed contact pair preferably being aligned in the same horizontal plane.

Each vertical loop 142L, 142T (FIG. 8) affords electrical linking of the fixed contact rod 134L, 134T with an associated fixed conducting lug arranged opposite in the bottom 74 of the lower part 24, belonging to a pair of conducting lugs P5L-P6L or P5T-P6T of a tag of the flex cable 28.

In order to immobilize each fixed contact rod 134L, 134T in the corresponding vertical slot 144L, 144T of the housing, it may be received in this slot with slight lateral clamping between the opposed walls of the slot.

In the same manner as for the turns of the springs, the fixing of each fixed contact rod can be improved through an operation of thermowelding by localized heating of a span of the straight body 138L, 138T with the aid of two electrodes that come to bear for this purpose.

In the same manner as for the springs, the hearing force exerted by the electrodes during the passage of the current then applies a heating force to the loop 142L, 142T, on the associated fixed conducting lug, which is maintained after the application of the electrodes.

The electrical contact established (see FIGS. 7A and 7B) between a lower span 78L, 78T of the mobile contact rod 70L, 70T with one or other of the two spans 140L, 140T corresponds to the coming into contact of two cylindrical surfaces with perpendicular axes, that is to say a so-called “crossed rollers” contact which is the best type of semi-permanent electrical contact.

Moreover, each free end span 140L, 140T exhibits a capacity for elastic deformation allowing “accompaniment” of the free end span 78L, 78T.

This phenomenon of accompaniment makes it possible to absorb any dimensional variations of the coding springs, thereby avoiding large variations of the snap-fastening loads.

Moreover, it dampens the mechanical impact between the spans 78L, 78T and the spans 140L, 140T.

In so far as, in the case of rapid rotation of the ball 30, the period between two impacts may be less than 2 ms, the risks of spurious bounce are thus reduced.

Moreover, the accompaniment by elastic deformation achieves a self-cleaning effect between the cylinders in contact.

The mobile and fixed contact rods may be produced from a metal wire made of steel or of copper alloy previously plated with gold or silver.

The electrical contact no longer depends on an accurate length of the mobile contact rod 70L, 70T, nor on the quality of the sectioning of its free end 78L, 78T.

The bulkiness of the new fixed contacts is particularly reduced, this allowing a large increase in the total number of turns of each spring, and hence a proportional reduction in the snap-fastening couple when fitting the loop 68L, 68T into the pinion 44L, 44T.

Hence, it is thus possible to reduce the diameter of each roller 42L, 42T without modifying the frictional forces and hence the possible risks of slippage between each elastomer roller 42L, 42T and the surface of the trackball 30.

With respect to the state of the art, the diameter of each roller is for example reduced by ⅓. This reduction makes it possible to increase the number of pulses per revolution of the ball in a ratio of 3/2.

It is also possible to reduce the eccentricity of the ball with respect to the center of the upper face of the device.

The total height of the housing is reduced without modifying the total height of the device, that is to say the height between the lower face of the lower part 24 of the housing and the apex of the trackball 30.

It is thus possible to increase the height of the part of the ball that emerges beyond the upper face 144 of the housing 22, thereby making it possible to install the device in equipment whose housing walls are larger.

According to a variant (not represented), it is also possible to double the number of fixed contacts for each coding spring, by providing two intermediate contact rods, of slightly different height, placed one above the other in the same slot and hearing on separate conducting lugs.

Such a solution allows independent doubling of the outputs of the device providing simultaneous signals.

Finally, the reduction in the eccentricity of the ball allows a better arrangement of the internal components of the device and in particular of the light-emitting diodes 150L, 150T (FIG. 13) that may advantageously be placed close to one another in order to obtain, as appropriate, better mixing of the colors when two adjacent diodes are energized simultaneously to obtain a third color.

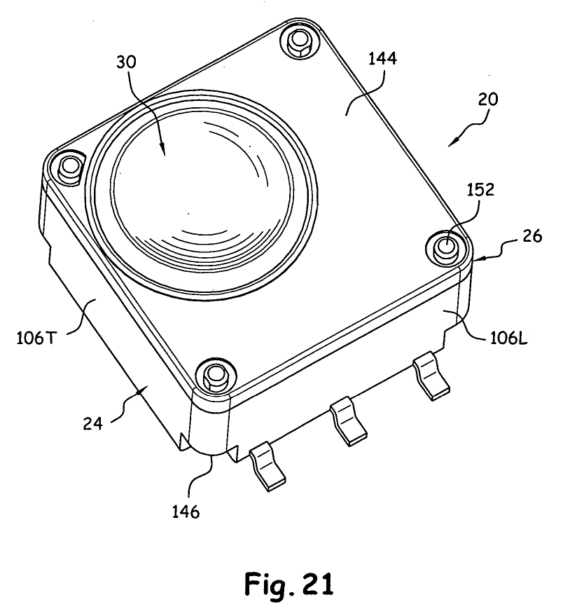

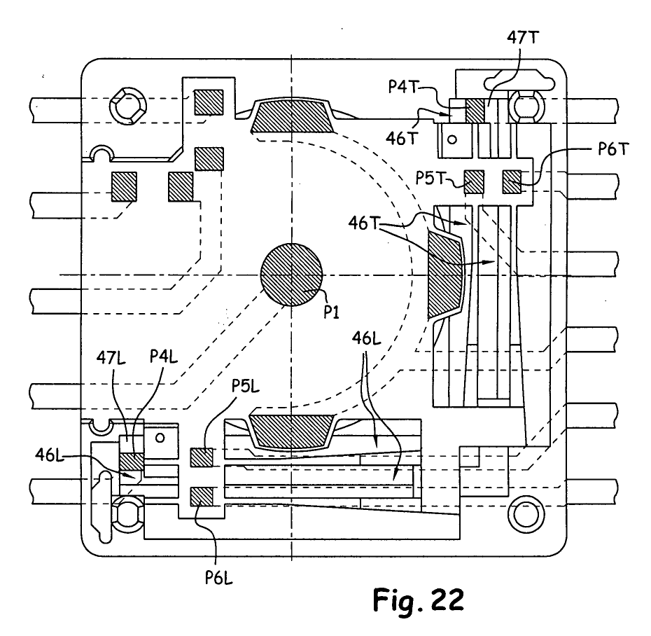

The embodiment represented in FIGS. 21 and 22 comprises a housing lower part 24 whose bottom is overmolded around fixed contacts which are extended outside via linking tabs or outputs which here are of transverse orientation and distributed equally in threes over the two opposite sides of the housing. The coplanar tabs which project from the housing are equivalent to the terminals of the flex 28 and they are joined to the fixed contacts Pi, arranged in the bottom 72, 74, by bands Fi embedded in the insulating molding material of the lower part.

The lugs P4L and P4T are bowed lugs of the electrical linking “grid” which replaces the flex cable 28.

The contact springs and rods 50L,50T-70L,70T can be realized in the form of a single element which is symmetrical and which can be used either as a longitudinal or transverse one 50L,T-58L,T-68L,T-70L,T.

Depending upon the size of the housing, the general length of the spring-rod element might be more or less important. When the ratio between this length and the diameter of the wire it is made of, is greater than 75 (seventy-five), it is possible to replace the torsion spiral spring 50L, 50T by a torsion bar spring, i.e. a torsion spring made of wire and whose external diameter is equal to the diameter of the wire.

It is sufficient that the elastic momentum or torque resulting from the cooperation between the loop 68L, 68T and the associated pinion 44L, 44T remains inferior to the driving momentum or torque of the trackball on the roller 42L, 42T.

The spring is thus greatly simplified, as well as the corresponding receiving portions of the lower part, and its overall length is reduced as can be seen in FIGS. 23 to 29 of this document.

In this case, it is a corresponding span of the second axial end of the torsion bar spring which is thermowelded into a complementary concave wall of the housing.

According to another solution, such a wire or bar spring can be a torsion and flexion spring especially when the guided length of the “bar” span is very short and dose to the oscillating or tilting loop 68L, 68T.

1. A control device comprising:
a housing;
a ball lying primarily in the housing and having an exposed ball top, said ball being pivotal about horizontal axes (L, T);
a pair of coding shafts rotatably mounted on the housing about perpendicular horizontal axes, each coding shaft having a roller in engagement with the ball and having a pinion with a plurality of teeth;
a pair of electrically conducting springs each having a main part mounted on said housing and having a contact rod with a contacting part and with a pinion-engaging part, said pinion-engaging part lying in the path of rotation of the teeth of a corresponding one of said pinions, so the pinion-engaging part is deflected to a deflect position every time the pinion turns far enough for a tooth thereof to almost lose engagement with the contact rod, and so the pinion-engaging part moves to a release position when the pinion-engaging part first loses engagement with the tooth, said contacting part of said contact rod moving between deflect and release positions as said pinion-engaging part respectively moves between said deflect and release positions;
two pairs of electrical terminals, each pair including a first terminal that is in continuous electrical connection to said spring and a second terminal positioned in the path of the contacting part of one of said contact rods to engage said contacting part of said contact rod in only one of its positions.

2. The control device described in claim 1 wherein:
said spring main part extends primarily parallel to the axis of the coding shaft that carries the corresponding pinion, and each contact rod extends approximately perpendicular to the main part, with said contacting part and pinion-engaging part extending in opposite directions from an imaginary extension of one end of said main part.

3. The control device described in claim 1 wherein:
said spring main part is in the form of a wire that is wound helically about a spring axis to form a helical coil, said wire having a first span that extends in a first direction primarily perpendicular to said spring axis and having an approximately 180° bend at an end of said first span that merges with said contact rod, and said helical coil having a far end portion that lies opposite said first span and that is fixed against rotation, the coil portion between said far end portion and said first span being free to turn by winding and unwinding of said coil.

4. The control device described in claim 1 wherein:
said housing has a lower housing part that is formed of a polymer, and that has a concave spring recess;
said spring main part is in the form of a multi-turn helical coil that lies in said spring recess, with at least one turn of said helical coil lying in a heat-displaced location of walls of said spring recess that prevents rotation of said one turn.

5. The control device described in claim 1 wherein:
each of said second terminals is formed of wire extending primarily perpendicular to one of said contact rods and having a contacting part positioned to be engaged by the contact rod.

6. The control device described in claim 5 wherein:
each of said contacting parts is cantilevered.

7. The control device described in claim 1 including:
a plurality of contact pads lying in said housing, each forming one of said first terminals;
said second terminals each has a pad-engaging portion that continually engages one of said contact pads, and each has a rod-engaging portion that lies in the path of a contacting part of one of said contact rods to engage it in its deflected position.

8. The control device described in claim 7 wherein:
each of said control rods is primarily straight; and each of said second terminals is in the form of a metal wire with said a pad-engaging portion forming a loop with one side of the loop pressing against one of said contact pads, said metal wire having a primarily straight portion extending perpendicular to said control rod.

9. A control device of the type comprising a plastic housing (22, 24, 26) in which is arranged at least one revolving coding shaft (32L, 32T) driven in rotation in opposite directions by a control member (30) mounted rotatably in the housing, and of the type in which each shaft is fixed in rotation to a mobile coding element (44L, 44T) belonging to a generator of control signals which comprises a mobile contact rod (70L, 70T) which, in its rest position toward which it is elastically restored, lies along a substantially vertical direction (V) in which a lower span (78L, 78T) of the rod is received with play between two opposed lateral lower contact elements (134L, 134T), and which is connected in rotation to the last turn (64L, 64T) of a first axial end of a torsional wound spring body (48L, 48T) of metal wire having a horizontal axis (52L, 52T), the spring body (48L, 48T) lying in the housing and having a second end (54L, 54T) which is immobilized in rotation while the contact rod is free to tilt about a horizontal axis (52L, 52T) parallel to the axis (40L, 40T) of the associated coding shaft (32L, 32T); characterized in that
said spring body second end lies in a duct (46L, 46T) of the housing with at least one turn of said second end being held by a heat-deformed part of said concave wall (47L, 47T) of the duct so as to immobilize the spring body in rotation.

10. The device described in claim 9 wherein:
each of the two opposed lateral lower contact elements is a straight rod (134L. 134T) which extends parallel to the axis of tilting of the mobile contact rod (70L, 70T) and which has a part fixed to the housing and which has a cantilevered free end span (140L, 140T) which lies opposite the lower span (78L, 78T) of the mobile contact rod and which is elastically deformable horizontally.

11. The device described in claim 10 wherein:
the lower span (78L, 78T) of the mobile contact rod and the free end span (140L, 140T) of the fixed contact rod (134L, 134T) are two spans of cylindrical rods.

12. A control device comprising:
a housing;
a coding shaft rotatably mounted in the housing;
a toothed pinion fixed in rotation to the coding shaft;
a lower contact element;
an elongated contact rod having a first end lying between two consecutive teeth of said pinion, said contact rod being mounted to tilt about an axis to first and second positions as the coding shaft turns, and said contact rod having a second end that moves against and away from said lower contact element as the contact rod tilts between said first and second positions.

13. The control device described in claim 12 including:
a trackball that is rotatable about two perpendicular axes in said housing;
two orthogonal revolving coding shaft elements, one of which is said coding shaft, each coding shaft element being rotatable by said trackball.

14. The device described in claim 12 including:
a length of wire that includes a portion wound into a largely helical coil with one end portion fixed to said housing and an opposite end portion forming said contact rod.

15. The control device described in claim 12 wherein:
said lower contact element is a wire pin that extends perpendicular to said control rod.

16. The control device described in claim 15 wherein:
said wire pin has a cantilevered end that lies in the path of said contact rod second end.

17. The control device described in claim 12 including:
a spring formed of spring wire having a main spring portion wound into a helix, a far end portion of said spring being fixed to said housing and an opposite rear end forming said contact rod;
said far end portion being fixed to said housing by a portion of said housing being heat deformed about part of said far end portion.
